(19) United States
(12) Patent Application Publication
(10) Pub. No.: US 2025/0038252 A1
(43) Pub. Date: Jan. 30, 2025

(54) SULFIDE-BASED SOLID ELECTROLYTE AND BATTERY

(71) Applicants: Hyundai Motor Company, Seoul (KR); Kia Corporation, Seoul (KR); Research & Business Foundation Sungkyunkwan University, Suwon (KR)

(72) Inventors: Sun Ho Choi, Incheon (KR); Yong Jun Jang, Seongnam (KR); Yong Gu Kim, Suwon (KR); Seong Hyeon Choi, Seongnam (KR); Sa Heum Kim, Seoul (KR); Sung Man Cho, Gwacheon (KR); Sang Uck Lee, Bucheon (KR); Ji Hoon Kim, Ansan (KR); Ji Won Lee, Suwon (KR); Ji Seon Kim, Suwon (KR)

(21) Appl. No.: 18/531,034

(22) Filed: Dec. 6, 2023

(30) Foreign Application Priority Data
Jul. 28, 2023 (KR) 10-2023-0099070

(51) Int. Cl. H01M 10/0562; C01B 25/08

(52) U.S. Cl. CPC H01M 10/0562; C01B 25/088; C01P 2002/76; C01P 2006/40; H01M 2220/20; H01M 2300/008

(57) ABSTRACT

The present disclosure relates to a sulfide-based solid electrolyte having a new composition and a new crystal structure.

### CROSS-REFERENCE TO RELATED APPLICATION

This application claims under 35 U.S.C. § 119 (a) the benefit of priority to Korean Patent Application No. 10-2023-0099070 filed on Jul. 28, 2023, the entire contents of which are incorporated herein by reference.

### BACKGROUND

### (a) Technical Field

The present disclosure relates to a sulfide-based solid electrolyte having a new composition.

### (b) Background

Nowadays, secondary batteries are widely used in large devices such as automobiles, power storage systems, etc. as well as small devices such as mobile phones, camcorders, laptop computers, etc.

As the fields of application of secondary batteries are widening, there is an increasing demand for improved safety and higher performance of batteries.

A lithium secondary battery, which is one of the secondary batteries, has advantages of a high energy density and a large capacity per unit area compared to a nickel-manganese battery or a nickel-cadmium battery.

However, most electrolytes used in conventional lithium secondary batteries are liquid electrolytes such as organic solvents. Therefore, safety issues such as leakage of electrolyte and the risk of fire due thereto have been constantly raised.

Accordingly, interest in all-solid-state batteries using solid electrolytes rather than liquid electrolytes as an electrolyte used in order to increase the safety of lithium secondary batteries has recently been increased.

Since the solid electrolytes have incombustible or flame retardant properties, they have safety higher than that of the liquid electrolytes.

Solid electrolytes are divided into oxide-based solid electrolytes and sulfide-based solid electrolytes. The sulfide-based solid electrolytes have advantages of high lithium ion conductivity and being stable over a wide voltage range compared to the oxide-based solid electrolytes.

However, the sulfide-based solid electrolytes have a problem of generating toxic hydrogen sulfide (H₂S) gas by reacting with moisture in the air. Accordingly, attempts have been made to solve the problem as described above by substituting the compositions of the sulfide-based solid electrolytes, but there is a limitation in that they cannot deviate from the limits of the selected crystal structure.

### SUMMARY

In one aspect, we now provide a sulfide-based solid electrolyte that can exhibit a new crystal structure.

In another preferred aspect, a sulfide-based solid electrolyte is provided with high lithium ion conductivity. In a further preferred aspect, the solid electrolyte also generates a small generation amount of hydrogen sulfide gas.

In a one aspect, a compound is provided of the following Formula I:

Li₂ABS₄X₂ [Formula 1]
wherein A is indium (In), aluminum (Al), gallium (Ga), scandium (Sc), or yttrium (Y), B is phosphorus (P) or antimony (Sb), and each X may be the same or different and may include chlorine (Cl), bromine (Br), or iodine (I). In certain aspects, each X is the same (e.g. where X₂ in the above Formula I is Cl₂, Br₂, or I₂).

In an aspect, a sulfide-based solid electrolyte is provided that may be represented by the following Formula 1.

Li₂ABS₄X₂ [Formula 1]
wherein A may include indium (In), aluminum (Al), gallium (Ga), scandium (Sc), or yttrium (Y), B may include phosphorus (P) or antimony (Sb), and each X may be the same or different and may include chlorine (Cl), bromine (Br), or iodine (I). In certain aspects, each X is the same (e.g. where X₂ in the above Formula I is Cl₂, Br₂, or I₂).

In certain aspects, A in Formula I is indium (In). In certain aspects, A in Formula I is aluminum (Al). In certain aspects, A in Formula I is gallium (Ga). In certain aspects, A in Formula I is scandium (Sc). In certain aspects, A in Formula I is yttrium (Y).

In certain aspects, B in Formula I is phosphorus (P). In certain aspects, B in Formula I is antimony (Sb).

In preferred aspects, the compound or sulfide-based solid electrolyte may include at least one selected from the group consisting of Li₂InPS₄Cl₂, Li₂InPS₄Br₂, Li₂InPS₄I₂, and combinations thereof.

In certain aspects, the compound or sulfide-based solid electrolyte may have a monoclinic crystal structure.

In certain aspects, the compound or sulfide-based solid electrolyte may belong to the P2_{1/n}/n space group.

In certain aspects, the compound or sulfide-based solid electrolyte may include at least one anion cluster selected from the group consisting of PS₄³⁻, AS₄X₂⁷⁻, and a combination thereof, wherein X is as defined in Formula I.

In certain aspects, the compound or sulfide-based solid electrolyte may include anion clusters including PS₄³⁻ and AS₄X₂⁷⁻, and the sulfide-based solid electrolyte may have a crystal structure in which a first polyhedron made of PS₄³⁻ and a second polyhedron made of AS₄X₂⁷⁻ are connected while sharing an edge, wherein X is as defined in Formula I.

In certain aspects, the compound or sulfide-based solid electrolyte may include a plurality of anion clusters, the plurality of anion clusters may be arranged in a plurality of rows, and a moving pathway of lithium ions may exist in spaces between the plurality of rows.

According to the present disclosure, a sulfide-based solid electrolyte having different physical properties by having a new crystal structure can be obtained.

According to the present disclosure, a sulfide-based solid electrolyte having high lithium ion conductivity and a small generation amount of hydrogen sulfide gas can be obtained.

In further aspects, an electrode is provided that comprises one or more compounds or solid electrolytes of the above Formula I.

In additional aspects, an all-solid-state battery is provided that comprises an electrode that comprises one or more compounds or solid electrolytes of the above Formula I. In certain aspects, the electrode is an anode. In other certain aspects, the electrode is a cathode.

According to the present disclosure, an all-solid-state battery with improved initial coulombic efficiency can be obtained.

According to the present disclosure, an all-solid-state battery with improved capacity retention rate can be obtained.

Also provided is a vehicle including a compound or electrolyte of Formula I.

Further provided is a vehicle that comprise an all-solid state battery as disclosed herein.

A term “all-solid-state battery” as used herein includes or refers to a rechargeable battery (including a secondary battery) that includes an electrolyte in a solid state, e.g., gel or polymer (cured), which may include an ionomer and other electrolytic components for transferring ions between the electrodes of the battery.

Other aspects of the invention are disclosed infra.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 shows an all-solid-state battery according to the present disclosure.

FIG. 2 shows the crystal structure of a sulfide-based solid electrolyte according to the present disclosure.

FIG. 3 shows a pathway through which the sulfide-based solid electrolyte according to the present disclosure conducts lithium ions.

FIG. 4 shows a pathway through which a compound represented by Li₆PS₅Cl conducts lithium ions.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, dimensions of the structures are shown enlarged than actual for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part, but also the case where there is another part in the middle therebetween. Conversely, when a part of a layer, film, region, plate, etc. is said to be “under” other part, this includes not only the case where it is “directly under” the other part, but also the case where there is another part in the middle therebetween.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to the maximum value including a maximum value, unless otherwise indicated. Furthermore, when such a range refers to an integer, all integers including from the minimum value to the maximum value including a maximum value are included, unless otherwise indicated. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

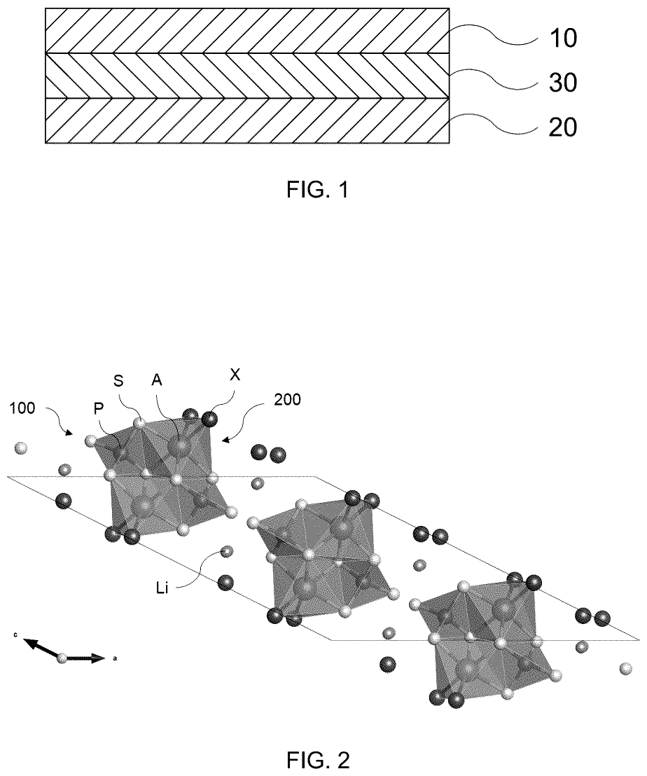

FIG. 1 shows an all-solid-state battery according to an embodiment of the present disclosure. The all-solid-state battery may include a cathode 10, an anode 20, and a solid electrolyte layer 30 interposed between the cathode 10 and the anode 20. At least one of the cathode 10, the anode 20, and the solid electrolyte layer 30 may include a sulfide-based solid electrolyte according to the present disclosure.

The sulfide-based solid electrolyte may include a compound represented by Formula 1 below.

Li₂ABS₄X₂ [Formula 1]
wherein A may include indium (In), aluminum (AI), gallium (Ga), scandium (Sc), or yttrium (Y), B may include phosphorus (P) or antimony (Sb), and each X may include chlorine (Cl), bromine (Br), or iodine (I).

In certain preferred aspects, the sulfide-based solid electrolyte may include at least one selected from the group consisting of Li₂InPS₄Cl₂, Li₂InPS₄Br₂, Li₂InPS₄I₂, and combinations thereof.

The present compounds (i.e. compounds of Formula (I)) may be readily prepared. For example, In₂S₃, InPS₄, and a lithium halide source such as LiBr, LiCl or Li may be admixed and thermally treated such as in sealed tube reaction at a temperature to complete reaction such as 1000K or greater to provide the desired compound (including in crystalline form). Reagents are commercially available or can be readily prepared. Exemplary syntheses are set forth in Examples 1-3 which follow.

Polycrystalline samples of the present compounds can be readily prepared e.g. by admixing the Li-halide (e.g, LiBr, LiCl, LiI) and InPS₄ in a 2:1 molar ratio and loading the admixture into a sealed reaction vessel placed under high vacuum such as 10⁻³ Pa. The reaction vessel then can be heated at a temperature and fir a time sufficient for reaction completion such as 723K for 72 to 120 hours following by cooling to provide the desired crystalline material.

In certain aspects, the sulfide-based solid electrolyte may have a monoclinic crystal structure and belong to the P2_{1/n} space group. In another aspect for evaluation purposes, cesium (Cs) is replaced with lithium (Li) in a compound represented by Cs₂InPS₄X₂ (X is chlorine (Cl), bromine (Br), or iodine (I)). Since cesium (Cs) has a larger atomic radius than lithium (Li), and both elements are Group 1 elements, cesium (Cs) can be replaced with lithium (Li). Table 1 below shows coordinate information on the three-dimensional space of the sulfide-based solid electrolyte according to the present disclosure belonging to the P2_{1/n} space group. Coordinate information was expressed as fractional coordinates.

TABLE 1

| Atom | x | y | z | Occ. | Site. |
|---|---|---|---|---|---|
| Li1 | −0.77459 | 0.10432 | −0.46104 | 1.00 | 4e |
| Li2 | −0.76251 | 0.57864 | −0.45462 | 1.00 | 4e |
| In1 | −0.75398 | 0.54985 | −0.68504 | 1.00 | 4e |
| P1 | −0.47869 | 0.41688 | −0.35609 | 1.00 | 4e |
| S1 | −0.52613 | 0.26747 | −0.47892 | 1.00 | 4e |
| S2 | −0.49881 | 0.28511 | −0.28238 | 1.00 | 4e |
| S3 | −0.22819 | 0.51510 | −0.17436 | 1.00 | 4e |
| S4 | −0.65635 | 0.62942 | −0.49099 | 1.00 | 4e |
| Br1 | −0.98210 | 0.83982 | −0.86819 | 1.00 | 4e |
| Br2 | −1.02599 | 0.34935 | −0.85072 | 1.00 | 4e |

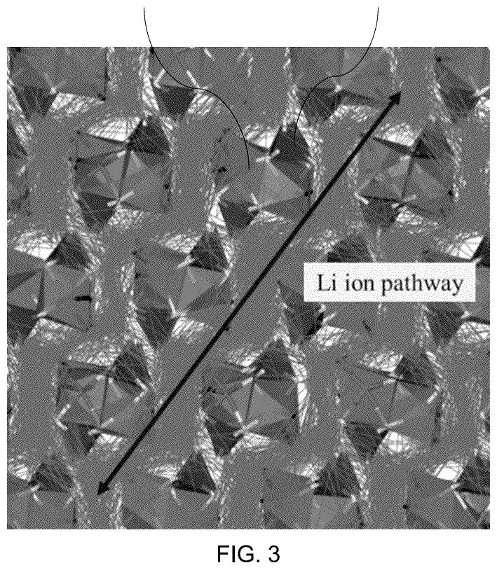

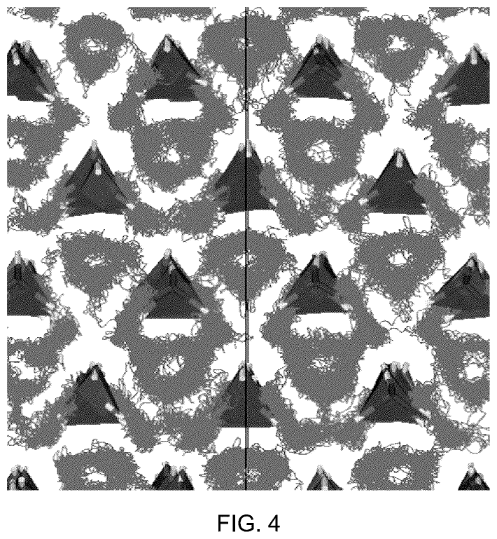

FIG. 2 shows the crystal structure of a sulfide-based solid electrolyte according to the present disclosure. FIG. 3 shows a pathway through which the sulfide-based solid electrolyte according to an embodiment of the present disclosure conducts lithium ions. FIG. 4 shows a pathway through which a compound represented by Li₆PS₅Cl conducts lithium ions.

Referring to FIG. 2, in one embodiment, the sulfide-based solid electrolyte may include lithium ions (Li) and an anion cluster. The anion cluster suitably may include for example at least one selected from the group consisting of PS₄³⁻, AS₄X₂⁷⁻, and a combination thereof, wherein X is as defined in Formula I above. Specifically, the anion cluster may include a first polyhedron 100 made of PS₄³⁻ and a second polyhedron 200 made of AS₄X₂⁷⁻ wherein X is as defined in Formula I above. The sulfide-based solid electrolyte may have a crystal structure in which the first polyhedron 100 and the second polyhedron 200 are connected while sharing an edge.

Further, referring to FIG. 3, it can be seen that the depicted sulfide-based solid electrolyte includes a plurality of anion clusters, the plurality of anion clusters are arranged in a plurality of rows, and a moving pathway of lithium ions exists in spaces between the plurality of rows. In an embodiment, lithium ions in the sulfide-based solid electrolyte may actively move to the periphery of the first polyhedron 100 and the second polyhedron 200 without any hindrance. On the other hand, referring to FIG. 4, it can be seen that a compound represented by Li₆PS₅Cl is a crystal structure in which anion clusters are connected while sharing a corner, and the compound conducts lithium ions to the periphery of the anion clusters through a complicated pathway.

In one embodiment the sulfide-based solid electrolyte according to the present disclosure may be characterized in an aspect in that the generation amount of hydrogen sulfide is small. Existing compounds such as Li₇PS₆, Li₆PS₅X, and the like release hydrogen sulfide (H₂S) gas by reacting with moisture in the air or moisture introduced in the process since Li₂S as a raw material remains or crosslinking sulfur such as P₂S₇ or the like exists. Since the sulfide-based solid electrolyte according to an embodiment of the present disclosure uses LiX and APS₄ as raw materials, Li₂S does not remain and there is no crosslinking sulfur. In addition, the sulfide-based solid electrolyte reacts with element A, for example, indium (In), to form In₂S₄ or InPS₄ before elemental sulfur(S) reacts with moisture. As a result, the sulfide-based solid electrolyte according to preferred embodiments of the present disclosure can emit less hydrogen sulfide gas than conventional compounds.

Other aspects will be described in more detail through the following Examples. The following Examples are merely examples to aid understanding of the present disclosure, and the scope of the present disclosure is not limited thereto.

### Example 1-3: Compound Syntheses

The starting reagents include the following In₂S₃ (commercially available such as 99.99%, Aladdin), P₂S₅ (commercially available such as 99%, Aladdin), LiCl (commercially available such as 99.9%, Sigma-Aldrich), LiBr (commercially available such as 99.9%, Sigma-Aldrich) an LiI (commercially available) InPS₄ can be prepared by stoichiometric reaction of In₂S₃ and P₂S₅ at 773 K in sealed fused-silica tubes.

Polycrystalline samples of the compounds of the following Examples 1-3 can be suitably prepared by admixing the Li-halide (e.g, LiBr, LiCl, LiI) and InPS₄ in a 2:1 molar ratio and loading the admixture into a sealed reaction vessel placed under high vacuum such as 10⁻³ Pa. The reaction vessel then can be heated at a temperature and fir a time sufficient for reaction completion such as 723K for 72 to 120 hours following by cooling to provide the desired crystalline material.

### Example 1: Synthesis of Li₂InPS₄Cl₂

Li₂InPS₄Cl₂ (including as crystals) can be prepared by reaction of InPS₄ (548 mg), and LiCl (800 mg) added as a flux. The reagent mixture can be mechanically ground (e.g. mortar) and then was placed in a quartz tube. The tube is evacuated to 10⁻³ Pa and sealed by heat (e.g. flame). The reaction tube can be placed in a furnace and then thermally treated, for example: heat to 1000K or greater for 24 to 72 hours or more followed by cooling to thereby provide Li₂InPS₄Cl₂.

### Example 2: Synthesis of Li₂InPS₄Br₂

Li₂InPS₄Br₂ (including as crystals) can be prepared by reaction of InPS₄ (548 mg), and LiBr (800 mg) added as a flux. The reagent mixture can be mechanically ground (e.g. mortar) and then was placed in a quartz tube. The tube is evacuated to 10⁻³ Pa and sealed by heat (e.g. flame). The reaction tube can be placed in a furnace and then thermally treated, for example: heat to 1000K or greater for 24 to 72 hours or more followed by cooling to thereby provide Li₂InPS₄Br₂.

### Example 3: Synthesis of Li₂InPS₄I₂

Li₂InPS₄I₂, can be prepared as described in Examples 1 and 2 above with substitution of LiI in place of LiCl (Example 1) or LiBr (Example 2).

### Example 4

Hydrogen sulfide gas generation energies of the sulfide-based solid electrolyte according to the present disclosure and a conventional compound represented by Li₆PS₅X were measured. The hydrogen sulfide gas generation energy of the compound according to each composition was obtained as follows using density functional theory (DFT).
1) Design a pseudo-binary reaction formula for the composition of the product produced by the reaction of a sulfide-based solid electrolyte (SE) and moisture (H₂O).

C_{products}(SE,H₂O,x)=x·C(SE)+(1−x)C(H₂O) (1)
2) The reaction energy of the above formula is calculated as follows.

E_{reaction}(SE,H₂O,x)=E_{eq}(C_{products}(SE,H₂O,x))−E(C_{products}(SE,H₂O,x)) (2)

Here, eq means the phase equilibrium state (Equilibria) of the products obtained from Reaction Formula (1).
3) After calculating E_{reaction} for x by applying Reaction Formula (2) to a range of 0<x<1, the reaction at x with the lowest reaction energy is determined by a reaction formula of the sulfide-based solid electrolyte (SE) and moisture (H₂O).
4) In order to compare the reaction energies of various sulfide-based solid electrolytes (SE), the reaction formula is normalized with respect to hydrogen sulfide (H₂S).
5) Hydrogen sulfide gas generation energy can be obtained by dividing the reaction energy by a conversion factor that considers the conversion ratio in which sulfur(S) contained in the sulfide-based solid electrolyte (SE), which is a reactant, participates in hydrogen sulfide gas generation.

An example of obtaining the hydrogen sulfide gas generation energy of Li₆PS₅Cl is as follows.
1) The pseudo-binary reaction formula generated using Li₆PS₅Cl and H₂O is as follows.

C_{products}(Li₆PS₅Cl,H₂O,x)=x·Li₆PS₅Cl+(1−x)H₂O
2) When x is 0.2, the reaction energy is lowest.

$$\begin{matrix}{E}_{reaction} ( {L i}_{6} {P S}_{5} Cl , {H}_{2} O , 0.2 ) = \begin{matrix}{E}_{eq} ( 0.2 {Li}_{3} {PO}_{4} + 0.4 Li HS + 0.6 {H}_{2} S + \\ 0.2 LiCl ) - ( 0.2 E ( {Li}_{6} {P S}_{5} Cl ) + 0.8 E ( {H}_{2} O ) )\end{matrix} \\ = - 10.6 eV / atom\end{matrix}$$

3) Normalize to 0.6 which is an equivalent of H₂S.

$${E}_{reaction} = - 10 \text{.60} / 0.6 = - 1 7.67 eV / atom$$

4) The conversion factor reflecting the fact that sulfur(S) contained in 0.2 Li₆PS₅Cl produces 0.6H₂S is 0.6 (0.6/0.2×5).

$${E}_{reaction} = - 1 7.67 eV / atom \times 0.6 = - 1 0.6 eV / atom$$

The hydrogen sulfide gas generation energy of the sulfide-based solid electrolyte according to the present disclosure and the conventional compound represented by Li₆PS₅X is shown in Table 2 below.

TABLE 2

| | | H₂S gas |
|---|---|---|
| | | formation |
| Composition | Hydrolysis reaction | energy (eV) |
| Li₂InPS₄Cl₂ | 0.4Li₂InPS₄Cl₂ + 2.8H₂O → H₂S + 0.2In₂S₃ + 0.4LiCl + | −0.02 |
| | 0.4H₇ClO₃ + 0.4LiP(HO₂)₂ | |
| Li₂InPS₄Br₂ | 0.33Li₂InPS₄Br₂ + 1.33H₂O → H₂S + 0.11In₂S₃ + 0.33LiBr + | −0.06 |
| | 0.11InBr₃ + 0.33LiP(HO₂)₂ | |
| Li₂InPS₄I₂ | 0.375Li₂inPS₄I₂ + H₂O → H₂S + 0.25InI₃ + 0.125InPS₄ + | −0.15 |
| | 0.25Li₃PSO₄ | |
| Li₆PS₅Cl | 0.33Li₆PS₅Cl + 1.33H₂O → H₂S + 0.67LiHS + 0.33LiCl + | −0.44 |
| | 0.33Li₃PO₄ | |
| Li₆PS₅Br | 0.33Li₆PS₅Br + 1.33H₂O → H₂S + 0.33LiBr + 0.33Li₃PO₄ + | −0.36 |
| | 0.67LiHS | |
| Li₆PS₅I | 0.33Li₆PS₅I + 1.33H₂O → H₂S + 0.33LiI + 0.33Li + ₃PO₄ + | −0.23 |
| | 0.67LiHS | |

The lower the hydrogen sulfide gas generation energy, the more hydrogen sulfide gas is produced. Referring to Table 2, the sulfide-based solid electrolyte according to the present disclosure has higher hydrogen sulfide gas generation energy than the compound represented by Li₆PS₅X. That is, it can be said that the sulfide-based solid electrolyte according to the present disclosure has a low release amount of hydrogen sulfide.

### Example 5

When a sulfide-based solid electrolyte comes into contact with a cathode active material, a side reaction may occur at an interface therebetween. Therefore, an interfacial reaction energy capable of knowing how stable the sulfide-based solid electrolyte is with respect to the cathode active material through computer simulation was calculated as follows.

$$x \cdot {C}_{a} + ( 1 - x ) \cdot {C}_{b} \to {C}_{equil} \qquad ( eq l )$$

(Cₐ, C_{b}=composition of the two materials in contact, C_{equil}=low phase equilibrium energy, 0<x<1)

$$Δ E [ {C}_{a} , {C}_{b} ] = min \{ {E}_{pd} [ x \cdot {C}_{a} + ( 1 - x ) \cdot {C}_{b} ] - x \cdot E [ {C}_{a} ] - ( 1 - x ) \cdot E [ {C}_{b} ] \} \qquad ( eq 2 )$$

(E_{pd}=lowest energy combination of reaction products in xCₐ+(1−x)C_{b})

The associated energies calculated by density functional theory (DFT) can be obtained from the database of a material project. In addition, the function to find the minimum value is in the material project. In order to explain phenomena in batteries, eq 3 is derived by using eq 2.

$${Φ}_{pd} [ c , {μ}_{Li} ] = min \{ {E}_{pd} [ c + {μ}_{Li} ] - {n}_{Li} [ c ] {μ}_{Li} \} \qquad ( eq 3 )$$

Φ_{pd} [c, μ_{Li}] means that composition c has the lowest energy in μ_{Li}. At this time, the lithium potential determined by the calculated average cathode voltage is used.

The following eq 4 is a formula for determining interfacial stability and is a function of μ_{Li}. The great potential at the interface is changed by allowing the sulfide-based solid electrolyte to equilibrate with the external lithium potential and react with the cathode. Δϕ determines the thermodynamic stability.

$$Δ {Φ}_{pd} [ {C}_{cathode} , {C}_{electrode} , {μ}_{Li} ] = min \{ {Φ}_{pd} [ x \cdot {C}_{cathode} + ( 1 - x ) \cdot {C}_{electrode} , {μ}_{Li} ] - x \cdot Φ [ {C}_{cathode} , {μ}_{Li} ] - ( 1 - x ) \cdot Φ [ {C}_{cathode} , {μ}_{Li} ] \} \qquad ( eq 4 )$$

Finally, the interfacial reaction energy between the sulfide-based solid electrolyte and the cathode active material can be determined using Δϕ. The results are shown in Tables 3 and 4 below.

TABLE 3

| | Cathode active material (meV/atom) | | | |
|---|---|---|---|---|
| Classification | LiCoO₂ | LiCo₂O₄ | LiMnO₂ | LiMn₂O₄ |
| Li₆PS₅Cl | −317.27 | −437.24 | −195.26 | −259.91 |
| Li₂InPS₄Cl₂ | −364.339 | −440.200 | −246.208 | −287.115 |
| Li₂InPS₄Br₂ | −370.62 | −458.11 | −243.30 | −290.50 |
| Li₂InPS₄I₂ | −358.93 | −476.87 | −250.41 | −311.62 |

TABLE 4

| | Cathode active material (meV/atom) | | | |
|---|---|---|---|---|
| Classification | LiNiO₂ | LiNi₂O₄Li₃₆Mn₃Co₄Ni₂₉O₇₂ | Li₃₆Mn₁₁Co₇Ni₁₈O₇₂ | Li₃NiMnCoO₆ |
| Li₆PS₅Cl | −485.75 | −439.21 | −313.80 | −293.10 |
| Li₂InPS₄Cl₂ | −571.588 | −514.219 | −379.100 | −352.493 |
| Li₂InPS₄Br₂ | −573.39 | −515.18 | −380.59 | −352.49 |
| Li₂InPS₄I₂ | −575.84 | −393.72 | −393.92 | −396.66 |

Referring to Tables 3 and 4, it can be seen that the sulfide-based solid electrolyte according to the present disclosure has lower interfacial reaction energy for all cathode active materials than Li₆PS₄Cl. Through this, it can be confirmed that a more stable all-solid-state battery can be obtained by using a sulfide-based solid electrolyte according to an embodiment of the present disclosure.

Since the Examples and specification have been described in detail above, the scope of rights of the present disclosure is not limited to the above-described Examples or specification, and various modifications and improved forms of those skilled in the art using the basic concept of the present disclosure defined in the following claims are also included in the scope of rights of the present disclosure.

What is claimed is:

1. A compound of the following Formula 1:
Li₂ABS₄X₂ [Formula I]
wherein in Formula I: A comprises indium (In), aluminum (Al), gallium (Ga), scandium (Sc), or yttrium (Y), B comprises phosphorus (P) or antimony (Sb), and each X comprises chlorine (Cl), bromine (Br), or iodine (I).

2. A solid electrolyte comprising a material represented by the following Formula 1:
Li₂ABS₄X₂ Formula I]
wherein A comprises indium (In), aluminum (Al), gallium (Ga), scandium (Sc), or yttrium (Y), B comprises phosphorus (P) or antimony (Sb), and each X comprises chlorine (Cl), bromine (Br), or iodine (I).

3. The solid electrolyte of claim 2, wherein the solid electrolyte comprises at least one selected from the group consisting of Li₂InPS₄Cl₂, Li₂InPS₄Br₂, Li₂InPS₄I₂, and combinations thereof.

4. The solid electrolyte of claim 1, wherein the solid electrolyte has a monoclinic crystal structure.

5. The solid electrolyte of claim 1, wherein the solid electrolyte belongs to the P2_{1/n} space group.

6. The solid electrolyte of claim 1, wherein the solid electrolyte comprises at least one anion cluster selected from the group consisting of PS₄³⁻, AS₄X₂⁷⁻, and a combination thereof.

7. The solid electrolyte of claim 1, wherein the solid electrolyte comprises anion clusters comprising PS₄³⁻ and AS₄X₂⁷⁻, and the solid electrolyte comprises a crystal structure in which a first polyhedron made of PS₄³⁻ and a second polyhedron made of AS₄X₂⁷⁻ are connected while sharing an edge.

8. The solid electrolyte of claim 1, wherein the solid electrolyte comprises a plurality of anion clusters, the plurality of anion clusters are arranged in a plurality of rows, and a moving pathway of lithium ions exists in spaces between the plurality of rows.

9. A composition comprising a compound of claim 1.

10. An electrode comprising a composition of claim 1.

11. A battery comprising a composition of claim 1.

12. A battery comprising an electrode of claim 10.

13. An all-solid-state battery comprising an electrolyte of claim 2.

14. A vehicle comprising a battery of claim 12.
